(19) United States
(12) Patent Application Publication
(10) Pub. No.: US 2008/0134858 A1
(43) Pub. Date: Jun. 12, 2008

(54) Bolt Lock For Left Handed Threaded Bolts

(75) Inventor: James Aston, Monclova, OH (US)

Correspondence Address: RANKIN, HILL & CLARK LLP, 925 EUCLID AVENUE, SUITE 700, CLEVELAND, OH, 44115-1405, US

(73) Assignee: DIAMOND PRODUCTS, LIMITED, Elyria, OH (US)

(21) Appl. No.: 11/950,766

(22) Filed: Dec. 5, 2007

Related U.S. Application Data
(60) Provisional application No. 60/873,660, filed on Dec. 8, 2006.

(51) Int. Cl. B26D 7/26

(52) U.S. Cl. 83/698.11; 125/13.01

(57) ABSTRACT

The invention provides a bolt lock for attachment to the blade collar of a concrete saw. The collar serves to stabilize the position of the blade collar bolt thereby helping to prevent the bolt from loosening, which can in turn lead to the blade falling off the concrete saw.

### BACKGROUND OF THE INVENTION

1. Field of the Invention

A bolt lock for attachment to the blade collar of a concrete saw stabilizes the position of the blade collar bolt which secures the blade collar and blade upon a concrete saw.

Concrete saw manufacturers traditionally use bolts with left handed threads to hold the blade collars in place on the right side of the saw. Manufacturers of concrete saws either omit the lock washer or they use a conventional lock washer for the right hand threaded bolt. If a saw operator fails to torque the bolt holding the blade collars properly or the threads are worn, the bolt has the potential to come loose.

2. Description of Related Art

We are aware of several incidents where this has occurred causing personal injury and property damage. Diamond saw blades on large concrete saws can spin at over two thousand revolutions per minute. The saw blades can be as large as 60 inches in diameter and weigh in excess of 100 pounds. If a blade comes loose from a concrete saw it has the potential to be very dangerous. We are aware of incidents where the blades have traveled hundreds of yards after coming loose from a concrete saw.

Operators of concrete saws frequently remove and replace the diamond blades on their concrete saws. There may be times when an operator will remove and replace different size blades in excess of 10 times during an eight hour period. Operators of concrete saws have a tendency to approach this casually and fail to realize the importance of proper torque when tightening the bolt holding the collar in place. There are several reasons why failure can occur:

Inadequate operator training.

The wrenches supplied by some manufacturers are inadequate to provide the 125-150 ft. lbs of torque suggested. Many manufacturers supply an open ended wrench only eight inches long.

The split lock washer provided is one designed for a right hand threaded bolt not a left hand threaded bolt.

The split lock washers that some manufacturers provide with concrete saws are not replaced on a regular basis. When they are replaced, the replacement is a standard washer carried at a hardware store and not a Grade 8 washer matched to the Grade 8 bolt holding the collar.

Operators will replace blades without removing the blade guards. While this may save time, it makes it impossible to tighten the bolts holding the collar with the open ended wrenches supplied by many manufacturers.

### BRIEF DESCRIPTION OF THE DRAWINGS

FIG. 1 is a perspective view of the bolt lock of the present invention.

FIG. 2 is an edgewise view of the bolt lock of the present invention.

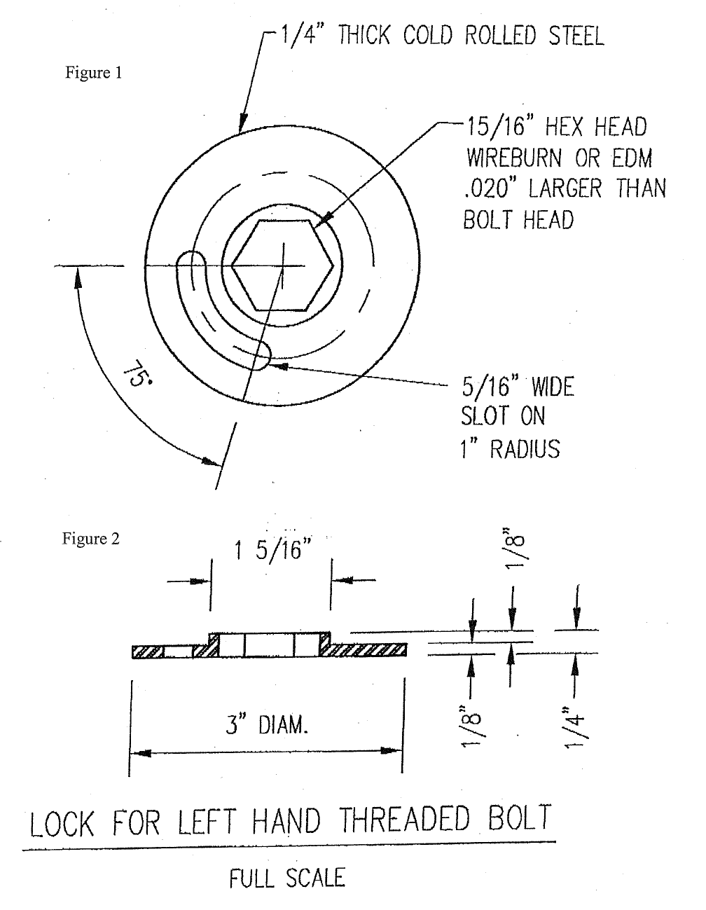

### DETAILED DESCRIPTION OF THE INVENTION

The bolt lock we are proposing slips over the bolt holding the blade collar in place after it has been tightened. It is machined so it is slightly larger than the head of the bolt. The outside collar has been altered in two ways. First, it has been machined so the center 3″ is perfectly flat for 3″. Secondly, 1½″ from the center it has a threaded hold for a ¼″ bolt.

The operator tightens the bolt holding the outside collar as they have always done. This bolt should be tightened to the manufacturer's specifications. Once this bolt is in place, they slip the bolt lock in place. The bolt lock has a slot 1½″ from the center slightly larger than ¼″ wide. This slot extends 75 degrees. Regardless of the position of the collar bolt, the slot allows the operator to thread a ¼″ bolt into the outer blade collar.

The bolt lock can easily be installed and removed in thirty seconds. The bolt lock is durable and will last for months through thousands of uses. When installed properly, it will provide security insuring the bolt holding the outside collar will not come free.

If manufacturers incorporated the bolt lock into their saws, it would eliminate the potential liability they are currently exposed to if blades should come off of their concrete saws.

The following publications are incorporated herein by reference:

US Patent Publication No. 2002/0117161 to Meister

US Patent Publication No. 2003/0168054 to Governo et al.

US Patent Publication No. 2004/0031475 to Markley

U.S. Pat. No. 5,743,247 to Kingsley et al.

U.S. Pat. No. 6,019,433 to Allen

U.S. Pat. No. 6,855,039 to Vidmore

PCT Patent Publication No. WO 2005/028287 to Iwata et al.

1. A bolt lock for attachment to the blade collar of a concrete saw for stabilizing the position of the blade collar bolt which secures the blade collar and blade upon a concrete saw.
